(19) United States
(12) Patent Application Publication
(10) Pub. No.: US 2022/0137969 A1
(43) Pub. Date: May 5, 2022

(54) MULTI-VENDOR ACCELERATOR MANAGEMENT PROTOCOL INTEROPERABILITY

(71) Applicant: Dell Products L.P., Round Rock, TX (US)

(72) Inventors: Chitrak GUPTA, Bangalore (IN); Sreenivasula REDDY G, Cuddapah (IN); Sriparna SOM, Bangalore (IN); Aniruddha Suresh HEREKAR, Belgaum (IN)

(73) Assignee: Dell Products L.P., Round Rock, TX (US)

(21) Appl. No.: 17/084,404

(22) Filed: Oct. 29, 2020

(51) Int. Cl. G06F 9/30

(52) U.S. Cl. CPC G06F 9/30076; G06F 9/3017

(57) ABSTRACT

An information handling system may include at least one central processing unit (CPU); and a special-purpose processing unit implementing a particular management interface that is one of a plurality of management interfaces. The information handling system may be configured to: receive management instructions for the special-purpose processing unit, wherein the management instructions are in accordance with a cross-platform management interface different from the particular management interface; translate the management instructions into translated instructions that are in accordance with the particular management interface; and perform management of the special-purpose processing unit by causing the special-purpose processing unit to execute the translated instructions.

### TECHNICAL FIELD

The present disclosure relates in general to information handling systems, and more particularly to systems and methods for managing special-purpose processing units (accelerators), such as graphics processing units (CPUs).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is becoming more common for information handling systems to include special-purpose processing units, also referred to herein as accelerators. Throughout this disclosure, for the sake of concreteness, the specific example of GPUs will be discussed in detail. One of ordinary skill in the art with the benefit of this disclosure will understand its application to other types of special-purpose processing units, however, such as intelligence processing units (IPUs) or any other desired type of accelerator.

Currently, GPUs from different vendors may have different interfaces for performing management tasks (e.g., sideband management). For example, an NVIDIA® GPU may provide access via certain commands (e.g., via SMBus Post-Box Interface (SMBPBI), while an AMD® GPU may provide access via different commands. Management tasks may generally include accessing information such as temperature, health monitoring (e.g., power consumption, power supply status, etc.), usage statistics, memory errors, or other telemetry. Management tasks may also include making configuration changes, etc.

This makes management of systems that can include GPUs from different vendors or manufacturers somewhat cumbersome.

For example, in some embodiments, a single information handling system may include multiple GPUs that may not be from the same source. In other embodiments, a particular model of information handling system may be preconfigured with a GPU, and a customer may be able to select what type of GPU is desired. In these and other embodiments, a management controller may currently need to provide a plurality of interfaces for interoperating with multiple different types of GPUs. It would be desirable for the management controller to implement a single interface capable of interoperating with multiple vendors' GPUs.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with the management of special-purpose processing units may be reduced or eliminated.

In accordance with embodiments of the present disclosure, an information handling system may include at least one central processing unit (CPU); and a special-purpose processing unit implementing a particular management interface that is one of a plurality of management interfaces. The information handling system may be configured to: receive management instructions for the special-purpose processing unit, wherein the management instructions are in accordance with a cross-platform management interface different from the particular management interface; translate the management instructions into translated instructions that are in accordance with the particular management interface; and perform management of the special-purpose processing unit by causing the special-purpose processing unit to execute the translated instructions.

In accordance with these and other embodiments of the present disclosure, a method may include receiving, at an information handling system, management instructions for a special-purpose processing unit of the information handling system, wherein the special-purpose processing unit implements a particular management interface that is one of a plurality of management interfaces, and wherein the management instructions are in accordance with a cross-platform management interface different from the particular management interface; the information handling system translating the management instructions into translated instructions that are in accordance with the particular management interface; and the information handling system performing management of the special-purpose processing unit by causing the special-purpose processing unit to execute the translated instructions.

In accordance with these and other embodiments of the present disclosure, an article of manufacture may include a non-transitory, computer-readable medium having computer-executable instructions thereon that are executable by a processor of an information handling system for: receiving management instructions for a special-purpose processing unit of the information handling system, wherein the special-purpose processing unit implements a particular management interface that is one of a plurality of management interfaces, and wherein the management instructions are in accordance with a cross-platform management interface different from the particular management interface; translating the management instructions into translated instructions that are in accordance with the particular management interface; and performing management of the special-purpose processing unit by causing the special-purpose processing unit to execute the translated instructions.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example information handling system, in accordance with embodiments of the present disclosure; and

FIG. 3 illustrates a block diagram of an example architecture, in accordance with embodiments of the present disclosure.

### DETAILED DESCRIPTION

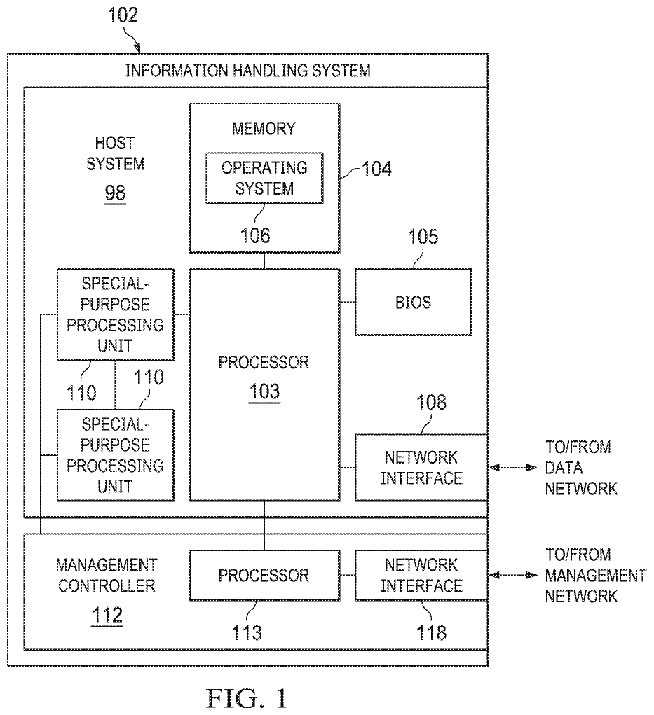

Preferred embodiments and their advantages are best understood by reference to FIGS. 1 through 3, wherein like numbers are used to indicate like and corresponding parts. For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time.

Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Information handling system 102 may include one or more special-purpose processing units 110. Special-purpose processing units 110 may include any type of processor other than a central processing unit (CPU). For example, special-purpose processing units 110 may include GPUs. Such GPUs may in various embodiments be integrated into a motherboard or backplane, be implemented on separate expansion cards (e.g., PCIe cards), or be implemented on a single expansion card. In some embodiments, special-purpose processing units 110 may also be coupled to management controller 112 (and/or processor 113 thereof) via any desired communications interface (e.g., via an I2C multiplexer).

Although FIG. 1 illustrates two special-purpose processing units 110, one of ordinary skill in the art will understand that any suitable number of such devices may be used. For example, some systems may include only one special-purpose processing unit 110, while others may include two or more. Further, some systems may include more than one processor 103. In various embodiments, special-purpose processing units 110 may be of the same type or of different types.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed in further detail below, embodiments of this disclosure provide various features for monitoring, analysis, and management of special-purpose processing units 110. These features may be implemented, in various embodiments, via code executable on processor 103 of host system 98 and/or on processor 113 of management controller 112.

In various embodiments, GPUs may be coupled to information handling systems in any desired fashion. For example, in a distributed GPU appliance scheme, a server node may be assigned GPUs as available, and as decided by an orchestrator. The management of GPU data may be provided in the GPU appliance chassis, or it may be provided by a management controller using a Distributed Management Task Force (DMTF) platform level data model (PLDM), for example over a PCIe interconnect. The management protocol supported by the management controller as a PLDM may not be supported by certain GPU models and/or manufacturers, however. Accordingly, embodiments of this disclosure may provide a mapping from the PLDM to the vendor-specific interface(s). Based on the detected capabilities of a GPU, a management controller may switch dynamically to any supported management mode. Thus a management controller according to this disclosure may be able to manage certain GPUs according to a PLDM, and other GPUs (which do not support the PLDM) according to a PLDM mapping.

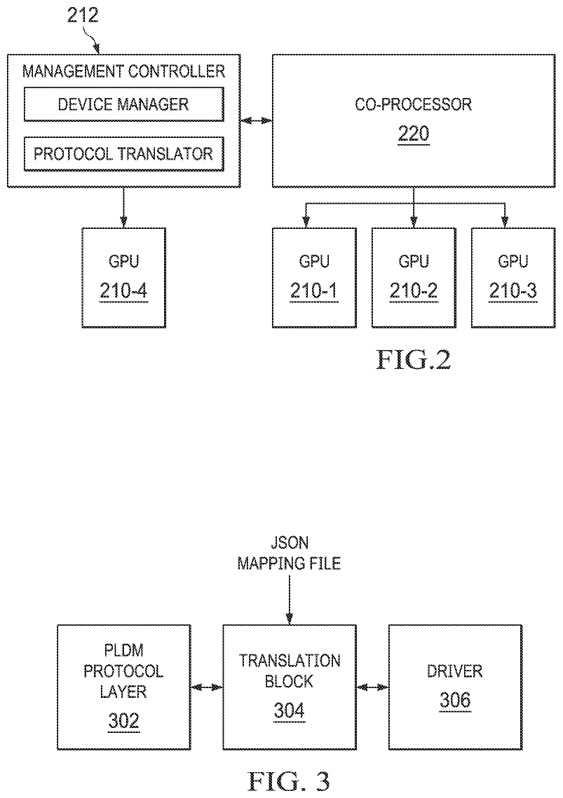

Turning now to FIG. 2, a block diagram of portions of an example information handling system is shown. Management controller 212 may be used to perform management of GPUs 210-1, 210-2, 210-3, and 210-4. In some embodiments, such management may be performed via an intermediary co-processor 220 (e.g., with respect to GPUs 210-1, 210-2, and 210-3). In these and other embodiments, such management may be performed without an intermediary co-processor (e.g., with respect to GPU 210-4).

In some embodiments, management controller 212 may support a PLDM base protocol, as well as a protocol translator. The protocol translator may be a configurable translation layer which takes as input a translation document and a binary command file which can be downloaded to the management controller. This may allow for the creation of a mapping between standard PLDM commands and commands that are specific to a particular GPU or original equipment manufacturer (OEM).

The PLDM commands may be standard commands. In some embodiments, the OEM commands (e.g., commands for GPUs that do not natively support the PLDM commands) may map directly to the PLDM specification in most cases. If an OEM does not support the PLDM specification for sideband accelerator management, then translation files may be provided to the protocol translator block of management controller 212. As discussed in further detail below, the translation files may be implemented in JSON, XML, or any other suitable format. The translation files may be generic mappings of the PLDM specification to the supported OEM commands, which may be implemented over I2C or any suitable communications bus. For example, a PLDM command to get temperature data may have a similar OEM command such as an SMBPBI I2C command for an NVIDIA® GPU.

The translation commands may be accompanied by I2C command mappings as specified by the translation requirements of the protocol translator block of management controller 212.

FIG. 3 provides a block diagram of an example architecture which may be used to implement portions of the present disclosure. This architecture may be implemented in a management controller such as management controller 112 or management controller 212, in some embodiments.

PLDM protocol layer 302 may be used to implement standardized commands including a standardized set of functionality according to a PLDM protocol. Translation block 304 may translate such standardized commands into OEM-specific commands based on the input of a mapping file such as a JSON mapping file. Driver 306 (which may be an I2C driver or a PCI/PCIe driver in various embodiments and may include vendor-defined messages (VDMs)) may then transmit the OEM-specific commands to a GPU.

According to some embodiments, a protocol mapping file may be defined to implement proprietary (e.g., OEM-specific) protocol commands. It may be used to dynamically map from standard PLDM commands to the proprietary protocol commands.

An example mapping is described below with reference to Appendix A. Appendix A is an example of a sample protocol mapping file in JSON format, which forms an integral part of the present disclosure.

The translation block may read the JSON file and map the standard PLDM commands to examples in a proprietary protocol (in this example, commands for an NVIDIA® GPU).

The GetCapability (Command code: 0x54, PLDMType: 2) tag details from the JSON file may be read, and the command may be sent to the GPU via I2C, SMBus, or any other suitable communications bus.

Response data may be received and mapped against the details from the JSON file, and then passed to the PLDM protocol layer in the required format.

A translation code block may provide a mechanism for handling the I2C command dispatches and mapping the protocol response to the PLDM response codes. The translation code block may provide PLDM response structure mapping to that of the OEM protocol response.

For example, NVIDIA® GPU capabilities may be read from a sideband using NVIDIA® SMBPBI commands (opcode 0x01 and possible argument values 0x1-0x5). The response data may be bit fields in sets of 32 bits. Each bit may represent a sub-function or capability. The capability may be supported for that device if that particular capability bit is set. Below is an example of a capability value in which a few temperature reading capability bits are set. A capability byte value of 100,663,297 in decimal corresponds to 110000000000000000000000001 in binary, which denotes:

1. Sensor measuring temperature of primary GPU (0:0)

2. Reading GPU slowdown temperature (Op 0x15, Arg1 0x01) supported (25:25)

3. Reading GPU shutdown temperature (Op 0x15, Arg1 0x02) supported (26:26)

Further, to read the NVIDIA device capabilities, the translator code may read the capabilities OEM command information and mapping details from the translator file. The translator may read the capability information from the device using an OEM I2C command. The translator may then map the I2C command response data to the PLDM format as per the mapping details mentioned in the translator file. Finally, the translator may populate the data into the PLDM format structures.

For example, Listing 1 below provides an example data structure format for PLDM device capabilities.

Listing 1.

```
  typedef struct CapabilityDetails {
  Devicetypeenum AcceleratorType; // type of device,
0=GPU, 1=IPU, . . .
  u32 CapabilityCount;
  CapabilityData CapabilityDataarray[ ];
  } CapabilityDetails;
  typedef struct CapabilityData {
  u16 CapabilityID; // 1 to n, where n is max supported
sub-functions
  u8 CapabilityName[32]; // name of the sub-function,
ex: temperature
  u32 Capabilityvalue; // 0=disabled, 1=enabled
  }CapabilityData;
```

Accordingly, embodiments of this disclosure may provide a mapping between a PLDM definition to any desired proprietary device commands. This may enable the OEM to implement proprietary protocols in a management controller by plugging in information about such protocols. A JSON-based protocol mapping file may be used to implement such functionality, and code translation may be used to map low-level I2C/PCI VDM commands to their corresponding commands.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one central processing unit (CPU); and
a special-purpose processing unit implementing a particular management interface that is one of a plurality of management interfaces;
wherein the at least one CPU of the information handling system is configured to:
receive management instructions for the special-purpose processing unit, wherein the management instructions are in accordance with a cross-platform management interface different from the particular management interface, and wherein the management instructions include instructions for accessing temperature information associated with the special-purpose processing unit;
translate the management instructions into translated instructions that are in accordance with the particular management interface; and
perform management of the special-purpose processing unit by causing the special-purpose processing unit to execute the translated instructions.

2. The information handling system of claim 1, wherein the special-purpose processing unit is a graphics processing unit (GPU).

3. The information handling system of claim 1, wherein the management instructions further include instructions for at least one of accessing health information, accessing usage statistics, or accessing memory error data.

4. The information handling system of claim 1, wherein the information handling system includes a plurality of special-purpose processing units.

5. The information handling system of claim 4, wherein at least two of the plurality of special-purpose processing units implement different ones of the plurality of management interfaces.

6. The information handling system of claim 4, wherein at least two of the plurality of special-purpose processing units correspond to different manufacturers.

7. The information handling system of claim 1, wherein the translating is performed via a management controller of the information handling system.

8. The information handling system of claim 1, wherein the at least one CPU is further configured to receive a translation file including data usable to perform the translating.

9. A method comprising:
receiving, at a central processing unit (CPU) of an information handling system, management instructions for a special-purpose processing unit of the information handling system, wherein the special-purpose processing unit implements a particular management interface that is one of a plurality of management interfaces, wherein the management instructions are in accordance with a cross-platform management interface different from the particular management interface, and wherein the management instructions include instructions for accessing temperature information associated with the special-purpose processing unit;
the CPU of the information handling system translating the management instructions into translated instructions that are in accordance with the particular management interface; and
the CPU of the information handling system performing management of the special-purpose processing unit by causing the special-purpose processing unit to execute the translated instructions.

10. The method of claim 9, wherein the special-purpose processing unit is a graphics processing unit (GPU).

11. The method of claim 9, wherein the management instructions include instructions for at least one of accessing health information, accessing usage statistics, or accessing memory error data.

12. The method of claim 9, wherein the translating is performed via a management controller of the information handling system.

13. An article of manufacture comprising a non-transitory,
computer-readable medium having computer-executable instructions thereon that are executable by a processor of an information handling system, the instructions for causing the processor to:
receive management instructions for a special-purpose processing unit of the information handling system, wherein the special-purpose processing unit implements a particular management interface that is one of a plurality of management interfaces, wherein the management instructions are in accordance with a cross-platform management interface different from the particular management interface, and wherein the management instructions include instructions for accessing temperature information associated with the special-purpose processing unit;
translate the management instructions into translated instructions that are in accordance with the particular management interface; and
perform management of the special-purpose processing unit by causing the special-purpose processing unit to execute the translated instructions.

14. The article of claim 13, wherein the special-purpose processing unit is a graphics processing unit (GPU).

15. The article of claim 13, wherein performing management of the special-purpose processing unit includes at least one of accessing health information, accessing usage statistics, or accessing memory error data.

16. The article of claim 13, wherein the information handling system includes a plurality of special-purpose processing units.

17. The article of claim 16, wherein at least two of the plurality of special-purpose processing units implement different ones of the plurality of management interfaces.

18. The article of claim 16, wherein at least two of the plurality of special-purpose processing units correspond to different manufacturers.

19. The article of claim 13, wherein the translating is performed via a management controller processor of a management controller of the information handling system.

20. The article of claim 19, wherein the instructions are further for causing the processor to receive a translation file including data usable to perform the translating.
